(19) United States
(12) Patent Application Publication
(10) Pub. No.: US 2026/0227982 A1
(43) Pub. Date: Aug. 6, 2026

(54) INSTALLING AN OPERATING SYSTEM IN A PROCESSOR DEVICE, IN PARTICULAR A SECURITY MODULE

(71) Applicant: GIESECKE+DEVRIENT MOBILE SECURITY GERMANY GMBH, Munchen (DE)

(72) Inventors: Thomas STOCKER, Munchen (DE); Steffen STEINMEIER, Munchen (DE); Barbara JAGER, Munchen (DE)

(21) Appl. No.: 19/151,800

(22) PCT Filed: Jan. 29, 2024
(86) PCT No.: PCT/DE2024/100073

§ 371 Date: Jul. 29, 2025

(30) Foreign Application Priority Data
Jan. 30, 2023 (DE) 10 2023 102 191.5

(51) Int. Cl. G06F 8/61; G06F 21/57

(52) U.S. Cl. CPC G06F 8/61; G06F 21/572; G06F 2221/033

(57) ABSTRACT

A method is for installing an OS in a processor device, which includes multiple sets of functionalities or their parts. The method involves loading and installing the OS or parts in the processor. Notably, the OS or parts are loaded as separate modules, each containing code to install a specific set of functionalities. This allows for the separate installation of only the relevant functionalities without installing additional sets.

### FIELD OF THE INVENTION

The invention relates to the installation of an operating system in a processor device, in particular a security module, namely a secure processor device with limited computing resources, and the updating of an installed operating system.

### PRIOR ART

Security modules, namely secure processor devices with limited computing resources, in the form of chip card products, have been known for a long time. SIM cards or UICCs (UICC=Universal Integrated Circuit Card) in the telecommunications sector, payment chip cards in the payments sector, health card chip cards and health professional ID chip cards in the health sector, as well as electronic identity cards with a chip and electronic passports with a chip as security modules in the identity sector are known as such chip card products. As security modules, further precursors for chip cards are known to also include (contact-based or/and contactless) inlays with a chip and an interface for electronic passports and chip cards. Operation of a chip card product requires a chip card product reader, to which the chip card product can be removably coupled in a contact-based or contactless manner.

Security modules (secure processor devices with limited computing resources), which functionally correspond to the further chip card products listed above without having a chip card product body, and which are embedded or soldered into a chip of a terminal with mobile radio capability (mobile terminal), or are implemented as secure software within a terminal with mobile radio capability (mobile terminal), are increasingly gaining traction. Such security modules are permanently coupled to the terminal with mobile radio capability (mobile terminal) and cannot or cannot easily be removed from it. Examples of security modules that are functionally equivalent to chip card products without being chip cards are embedded UICCs, eUICCs, and integrated UICCs, iUICCs, integrated into a chip of a mobile terminal, as well as SIM cards emulated in software, called eSIMs, in the telecommunications sector. In the payments sector, security modules without a chip card body include, for example, payment solutions held in a secure element within a mobile terminal or in an eUICC or in an iUICC. In the identity sector, security modules without a chip card body or comparable physical body include, for example, virtual electronic identity cards and virtual electronic passports provided in a secure element within a mobile terminal.

Each operational security module (secure processor device with limited computing resources) has an operating system that provides basic functionalities of the security module. The basic functionalities include operational functionalities such as memory management, including writing data to memory and reading data from memories of the security module. The basic functionalities further include functionalities for exchanging data with external units, for example with a terminal with mobile radio capability in which the security module is operated, or with a local or remote server. The functionalities for exchanging data include, for example, implementations of transmission protocols for exchanging data. The basic functionalities further include functionalities for protecting other functionalities, for example cryptographic algorithms, for example cryptographic algorithms for encrypting or/and decrypting data of any kind, or cryptographic algorithms for generating or/and verifying cryptographic signatures.

Operating systems for security modules are known in Java Card code as well as in native code.

Traditionally, in order to equip a security module with an operating system, the operating system as a whole is loaded into the security module and installed in the security module. For this purpose, the complete operating system is provided outside the security module in a suitable form, such that the operating system as a whole can be loaded into the security module and installed there, for example in the form of an installation package for the complete operating system.

Part of creating the operating system of security modules is the incorporation of cryptographic algorithms into the operating system. For this purpose, an operating system basic framework and one or more cryptographic algorithms are created separately as source code, and then the source codes of the one or more cryptographic algorithms are incorporated into the source code of the operating system basic framework. Similarly, libraries can be created separately from the operating system basic framework and then installed in the operating system basic framework.

If changes, such as updates or/and bug fixes, are subsequently made to the operating system, a complete changed version of the operating system is created outside the security module, in which the changes, such as updates or/and code patches for implementing bug fixes, are implemented, and the changed operating system as a whole is loaded into the security module and installed there, in a similar manner to that in which the original operating system was loaded and installed.

In the event of changes to the operating system for the security module, under certain circumstances only small portions of the operating system are affected by the changes, and other portions of the operating system remain unchanged in comparison with the version of the operating system already present in the security module. However, the entire operating system must be reloaded and reinstalled. This means that the amount of data to be loaded and installed can be very large compared to the changes made. Making the changes to the operating system is thus inefficient and slow.

Changes to the operating system may include, for example, updates or bug fixes or adaptations to changed use cases. For example, a changed use case may also be due to the fact that an operating system created for a first customer is also intended to be used for a second customer, who, although in principle uses the same use case as the first customer, wants different detailed solutions for partial aspects of the operating system. This allows the operating system created for the first customer to be reused, but with minor changes or adaptations.

For operating systems for security modules, there is a widespread need to certify the operating system. In order for the operating system to be certified, the operating system must be subjected to systematic tests by an approved certification body and pass the tests. If changes are made to the operating system, the entire operating system generally needs to be re-certified. Even if an operating system is intended to be used for two customers active in the same industry, with only minor variations between the operating system versions for the two customers, both operating system versions may need to be fully certified side by side and independently of each other.

A special scenario of a change to the operating system is the replacement of an implementation of a cryptographic algorithm integrated in the operating system, for example by an updated or debugged implementation of the same algorithm, or by another, e.g. more up-to-date, algorithm. For example, an implementation of the Advanced Encryption Standard AES, in which weaknesses have been discovered, could be replaced by a modified implementation of the AES. According to another example, the Data Encryption Standard DES could be replaced by the newer AES. Traditionally, for this purpose, outside the security module, the source code of the new or changed cryptographic algorithm is incorporated into the source code of the operating system basic framework in order to replace the previously existing source code of the cryptographic algorithm. The changed operating system, i.e. the source code of the entire changed operating system, comprising the source code of the new or changed cryptographic algorithm and the source code of the operating system basic framework, is then re-certified and loaded into the security module and installed in the security module.

It would be desirable to have a more efficient and more flexible solution for installing and changing, in particular updating, an operating system in a security module, which allows the operating system to be installed and changed, in particular subsequently updated, more quickly and with fewer resources.

The prior art document U.S. Pat. No. 8,522,234B2 discloses a computer-implemented method for tailoring the installation of a modular operating system into a computer system. The modular operating system comprises a base module and a plurality of installable feature modules. Based on desired performance properties of the operating system and predetermined operating capacity as well as available memory capacity of the computer system, parts of the modular operating system are selectively installed in order to achieve the desired performance properties in the best possible way while maintaining the operating capacity and available memory capacity. In order to achieve this, only the required modules, or those permitted in view of the operating capacity to be maintained and the memory capacity to be left free, are assembled by an operating system tailor and the operating system generated in this way is installed.

The prior art document U.S. Pat. No. 6,292,941B1 discloses a method for installing and customizing an operating system on a local computer, wherein a customized operating system is set up on the local computer by remotely customizing a standard operating system, provided locally in a removable memory of the local computer, with a customization model provided by a remote management computer.

### SUMMARY OF THE INVENTION

The invention is based on the object of providing a more efficient and more flexible solution for installing and changing, in particular updating, an operating system in a processor device, in particular a security module, which allows the operating system to be installed and changed, in particular subsequently updated, more quickly and with fewer resources.

The object is achieved by a method as claimed in claim 1. Advantageous configurations of the invention are specified in the dependent claims.

The core idea of the invention is to purposefully reduce installation to be performed to desired parts of the operating system by means of a modular installation solution, and to omit other parts of the operating system during installation or to provide them for other installation steps.

The method according to the invention as claimed in claim 1 is provided in detail for installing an operating system, or parts of an operating system, in a processor device. The operating system comprises a plurality of two or more operating system functionalities.

The method comprises steps of:—loading the operating system, or the parts of the operating system, into the processor device;—installing the loaded operating system, or the loaded parts of the operating system, in the processor device.

The method is characterized in that
a) the loading of the operating system, or the parts of the operating system, is carried out as loading at least one or more mutually separate operating system modules, wherein the operating system module or the respective operating system module:
b) contains code that is configured to install an operating system functionality corresponding to the operating system module in the processor device; and
c) allows only the operating system functionality corresponding to the respective operating system module to be installed separately, in particular without installing further operating system functionalities.

Providing the mutually separate operating system modules, each containing code that is configured to install an operating system functionality corresponding to the operating system module in the processor device, makes it possible to provide, in a tailored and targeted manner, only selected functionalities of the operating system for installation, and to then install them. Other operating system functionalities that are not currently to be installed, such as those that are not needed or remain unchanged, are not provided. Accordingly, the modular design of the code for installing the operating system, or the parts of the operating system, makes it possible to greatly reduce the volume of data to be installed. The reduced volume of data reduces the time and computing resources required for installation. This is equally true irrespective of whether the installation is aimed at initial installation of an operating system or parts thereof, or at a change, or an update, of an already installed operating system, or parts of such an operating system, or at a change of an operating system in the form of a change of parts of an operating system that have already been installed, or at a change in the form of an expansion of an installed operating system to include operating system parts that are not yet present.

Therefore, as claimed in claim 1, a method is provided in which the operating system can be installed and changed, in particular subsequently updated, more quickly and with fewer resources.

Another advantage of the invention is that, due to the smaller volume of data to be installed, the risk of data errors, data transmission errors when transmitting the code to the processor device and installation errors when installing the code in the processor device can be reduced.

Another advantage of the invention is that, on account of the possibility of loading and installing individual mutually separate operating system modules and thus operating system functionalities in isolation from each other, the possibility is opened up of evaluating the individual mutually separate operating system modules and thus operating system functionalities separately from each other and having them certified by approved certification bodies, for example accredited test laboratories. If only a specific operating system module and the associated operating system functionality are changed, then a suitable separation or isolation of the operating system modules from each other can ensure that only this operating system module and the associated operating system functionality must be recertified. The certification of the unchanged operating system modules and thus operating system functionalities remains unaffected.

For the separation or isolation of different executable program codes, different measures are known and can also be applied to the operating system modules according to the invention as executable program codes. Examples of measures for separating codes include contexts, security domains, and sandbox mechanisms.

Optionally, different operating system modules are arranged in different security domains, in particular global platform security domains, and are executed in the different security domains.

Optionally, the—or the respective—operating system module is furthermore d) isolated from other operating system modules such that access between the operating system module—or the respective operating system module—and other operating system modules is prevented or is only possible at best by means of controlled interface mechanisms. If the processor device is based on Java or Java Card, a shareable interface object or entry point object can be provided as a controlled interface mechanism, for example.

The installation of the operating system or the parts of the operating system is optionally carried out as separate installation of the loaded separate operating system modules. Alternatively, the installation of the operating system or the parts of the operating system is carried out as joint installation of the loaded separate operating system modules. Optionally, the installation is carried out as separate installation of the loaded separate operating system modules for some operating system modules, and as joint installation of the loaded separate operating system modules for some operating system modules.

Different scenarios for installing an operating system or parts of an operating system can include a different number of operating system modules, and/or different proportions of the operating system, in the maximum case the entire operating system. If a number of a plurality of operating system modules are loaded for installation in one go, the installation of the plurality of operating system modules can be carried out either individually or alternatively in a block, in which case the modularity no longer has an effect with regard to the installation process. Which installation procedure is advantageous in individual cases can depend on different boundary conditions.

Optionally, the following are provided as mutually separate operating system modules:
at least one trusted loader which is configured to load further operating system modules into the processor device, and to cause the further operating system modules to be installed in the processor device; and
additionally one or more functional operating system modules.

According to the embodiment described here, the trusted loader is optionally the first operating system module installed in the processor device, and subsequently enables further operating system modules to be loaded and installed in the processor device by means of the trusted loader.

The trusted loader is optionally not a functional operating system module itself, but is exclusively configured to load further operating system modules into the processor device, and to cause the further operating system modules to be installed in the processor device.

Optionally, in addition to the functionality of loading further operating system modules, the trusted loader already includes modules for basic functionalities of the operating system, such as:—memory management of memory units of the processor device;—reading or/and writing of data, including programs, in memory units of the processor device;—editing of instructions in the processor device, including reception of instructions, execution of instructions, creation of instructions, and outputting of instructions. Alternatively, these basic functionalities are provided by separate operating system modules.

Optionally, one or more of the following are provided as functional operating system modules:
a basic functionality module, the installation of which installs one or more basic functionalities of the operating system in the processor device;
a cryptographic algorithm module, the installation of which installs an implementation of a cryptographic algorithm in the processor device;
a library module, the installation of which installs a library in the processor device;
a protocol module, the installation of which installs an implementation of a protocol for communication between the processor device and units arranged outside the processor device;
an updated version of one of the preceding functional operating system modules that is loaded into the processor device and installed in the processor device as a replacement or supplement for a version of the same functional operating system module already installed in the processor device.

For example, a symmetric or asymmetric algorithm, such as DES, AES, 3DES, RSA, or another algorithm may be provided as a cryptographic algorithm.

The protocol provided can be optionally a transmission protocol for chip cards or similar chip-based products, such as ISO/IEC 7816 T=0 or T=1, ISO/IEC 14443, near field communication NFC, single wire protocol SWP or password authenticated connection establishment PACE for machine-readable travel documents. The protocol provided may also optionally be a transmission protocol for payment or telecommunications or identity/passport applications.

Alternatively, one or more of the following is or are provided as the basic functionality: memory management of memory units of the processor device; reading or/and writing of data, including programs, in memory units of the processor device; editing of instructions in the processor device, including reception of instructions, execution of instructions, creation of instructions, and outputting of instructions.

Optionally, the operating system module is designed as a Java Card CAP file according to the Java Card specification.

Alternatively, the operating system module contains Java Card code or native code, or both Java Card code and native code. In particular, a Java Card CAP file may additionally contain native code in addition to Java code.

Optionally, an operating system module is loaded by loading a service, in which the operating system module is integrated, into the processor device. In this case, a service for an operating system module for an operating system functionality should be understood as meaning an entity, in particular a program code, which is configured to ensure that the service, i.e. the program code for example, is executed. Executing the service loaded into the processor device (e.g. program code) installs the operating system functionality in the processor device.

Optionally, the operating system is at least partially or completely designed as a Java Card-based operating system. In this case, the service is designed as a Java Card applet and the operating system module is designed as a Java Card CAP file. The service is executed by calling and executing the Java Card applet. As a result, the operating system functionality corresponding to the Java Card CAP file is installed in the processor device. In this embodiment too, the Java Card CAP file may additionally contain native code in addition to Java code.

Optionally, the Java Card applet used to implement the service is designed as a modified Java Card applet which is modified to the effect that the modified Java Card applet cannot be called by the process( ) and select( ) instructions that can be used to call a standard Java Card applet, but only has a controlled interface object, in particular a shareable interface object or entry point object, and can be called thereby.

Optionally, in embodiments that use a Java Card applet, an application identifier, AID, is assigned to the Java Card applet, wherein a registry is set up in the processor device, in which the application identifier, AID, of the Java Card applet is entered when loading the applet into the processor device. In this case, the Java Card applet is called and executed based on the application identifier, AID, entered in the registry. Optionally, the Java Card applet is also called using a unified resource identifier string, URI string pointing to the service. If the URI string is called, the operating system functionality corresponding to the Java Card CAP file is installed in the processor device.

Optionally, different services for different operating system modules are carried out in different contexts which are isolated from each other. The contexts are optionally isolated, in particular, by means of the action of a microprocessor device MPU or/and memory management MPU. Optionally, interaction or communication between different services is possible only via a controlled interface mechanism, in particular a shareable interface object or/and an entry point object.

The isolation of the contexts is particularly advantageous in connection with the certification of the processor device. The isolation of the contexts can in particular contribute to reducing the effort of re-certification when changes are made to the operating system.

Optionally, the isolation of the contexts is designed to be sufficient to meet applicable certification requirements for the processor device, such that, when changes are made to an operating system module in a first context, the existing certifications of other operating system modules in other contexts that are isolated from the first context are not affected by the change.

This means that only the changed operating system module and the associated operating system functionality must be re-certified.

Optionally, each operating system module is certified separately. This means that, in a fully certified operating system in which only one individual operating system module, or a group of individual operating system modules, and the associated operating system functionality(functionalities) is(are) changed, the existing certification for the unchanged components of the operating system can be maintained, and only the changed operating system parts (module(s), functionality(functionalities)) must be re-certified.

Different hierarchically tiered levels of certification are provided in certification. The higher the level of certification, the stricter the test specifications. If a processor device has passed a certain level of certification, it is considered certified according to that level and all lower levels below it. Higher levels are considered not to have been reached and the processor device is not certified for the higher levels.

The higher the level of certification, the higher generally the range of possible uses of a certified processor device. Therefore, the highest possible level of certification is desirable. On the other hand, a high level of certification means a large number of measures, in particular security measures, which must be provided in the processor device in order to pass the certification test. Program routines for averting side-channel attacks, hacker attacks, and the like, such as masking, encryption, obfuscation, redundancies, and more, can be provided, for example, as measures. Time-consuming and costly development work is required to accordingly equip the processor device. In addition, the complexity of the product increases with the measures, which, if implemented carelessly, can entail error risks again. In addition, the tests for higher certification levels are more time-consuming and expensive than tests for lower certification levels.

Accordingly, the aim is not always to achieve the highest level of certification, but typically only a certification level that is sufficient for the specific application purpose.

The trusted loader loads other operating system modules into the processor device. Thus, the trusted loader influences every operating system module loaded by it. Accordingly, an operating system module loaded by the trusted loader can have at most the level of certification obtained (passed) by the trusted loader, even if the operating system module has obtained (passed) a higher level of certification outside the processor device.

Optionally, if a trusted loader is provided, the trusted loader has the highest or at least no worse level of certification relative to other operating system modules. This always maintains and never worsens the level of the other operating system modules that can be reloaded by the trusted loader.

In an analogous manner to the operating system modules, application modules for installing applications can be additionally loaded into the processor device. Optionally, some operating system modules may contain application modules and, with such an operating system module, application modules contained therein can also be loaded into the processor device and installed there.

Optionally, a security module, that is to say a secure processor device with limited computing resources, in particular a chip card or a corresponding processor module without a card-shaped body, is provided as a processor device.

Optionally, the processor device comprises:
at least one processor unit for processing data, including programs,
at least one memory unit, comprising one or more memories, for storing data, including programs,
at least one interface unit for exchanging data, including programs, with units arranged outside the processor device.

### BRIEF DESCRIPTION OF THE DRAWINGS

The invention is explained in more detail below on the basis of exemplary embodiments and with reference to the drawing, in which:

FIG. 1 shows a schematic representation of modular installation and modular expansion of an operating system by sequentially installing a plurality of operating system modules, according to embodiments of the invention;

FIG. 2 shows a schematic representation of an arrangement of a plurality of Java-based operating system modules to be executed in mutually isolated contexts, according to embodiments of the invention;

FIG. 3 shows an operating system module designed as a service, according to embodiments of the invention.

### DETAILED DESCRIPTION OF EXEMPLARY EMBODIMENTS

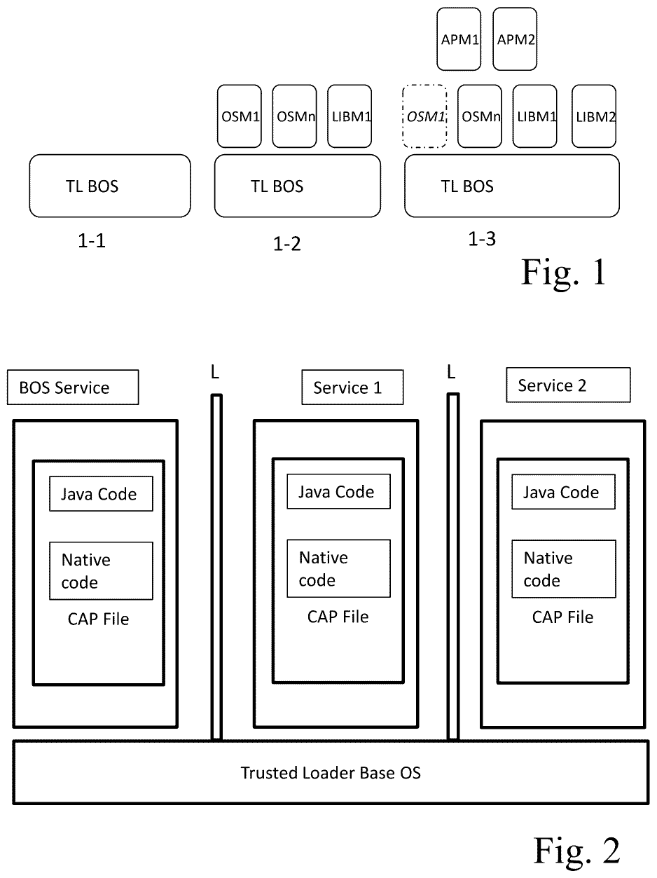

FIG. 1 shows a schematic representation of modular installation and modular expansion of an operating system by sequentially installing a plurality of operating system modules in a processor device, according to embodiments of the invention.

Subfigure 1-1 of FIG. 1 shows the processor device in a first state of installation 1-1, in which only a trusted loader TL is installed in the processor device. In this case, the trusted loader TL already comprises first basic functionalities BOS of the operating system. Alternatively, the basic functionalities BOS of the operating system could also only be loaded into the processor device by the trusted loader TL.

Subfigure 1-2 of FIG. 1 shows the processor device in a second state of installation 1-2, in which, in addition to the trusted loader TL with the basic functionalities BOS of the operating system according to subfigure 1-1, various operating system functionalities from two (or more) operating system modules OSM1, ( . . . ) OSMn and a library from a library module LIBM1 are installed in the processor device. For this purpose, the two operating system modules OSM1, OSMn and the library module LIBM1 have been loaded into the processor device, the modules OSM1, OSMn, LIB2 have been executed in the processor device, and thus the various operating system functionalities and the library have been installed in the processor device.

Subfigure 1-3 of FIG. 1 shows the processor device in a third state of installation 1-3, in which, in addition to the modules and functionalities shown in subfigure 1-2, a further library from a further library module LIB2 and two applications from two application modules APM1, APM2 have been installed in the processor device. In addition, operating system functionalities that had been installed from the first operating system module OS1 have been uninstalled or/and deleted.

FIG. 2 shows a schematic representation of a processor device that contains an arrangement of a plurality of Java-based (more precisely Java Card-specific) operating system modules to be executed in mutually isolated contexts, according to embodiments of the invention. The processor device contains a trusted loader TL. The trusted loader already itself contains basic functionalities of the operating system Base OS, or it has loaded the basic functionalities by loading one or more basic functionality modules and has installed them in the processor device. The processor device includes three services: BOS Service, Service 1, and Service 2. Each of the three services contains executable program code, the execution of which installs the service payload content in the processor device. Each of the three services is isolated from the other two services by a context boundary L, with the result that each service, when executed, is executed in its own isolated context.

Each service contains, as payload content, a CAP file according to the Java Card specification, in which the code to be installed is contained. In the embodiment shown in FIG. 2, the CAP file contains both Java code and native code.

A first of the three services BOS Service is an operating system module for installing further basic functionalities of the operating system.

A second of the three services Service 1 is an operating system module for installing a cryptographic algorithm in the processor device.

A third of the three services Service 2 is an operating system module for installing an integrated subscriber identity module iUICC in the processor device.

Further similar services can be loaded into the processor device and executed therein, for example in order to install a payment application or a wallet application in the processor device.

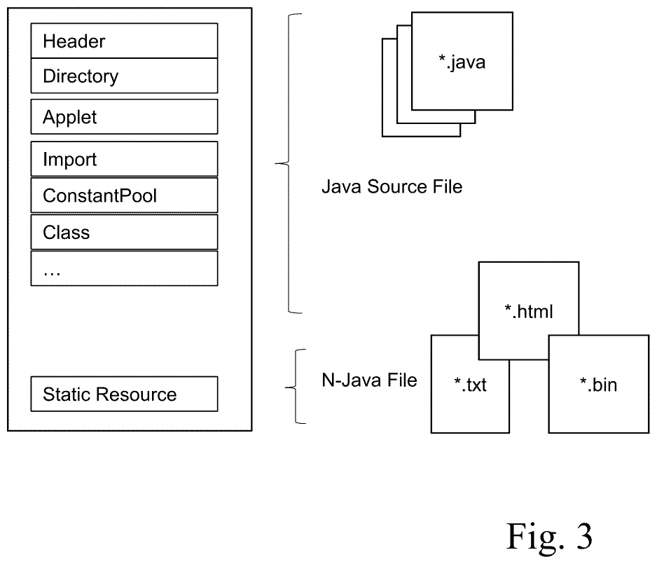

FIG. 3 shows an operating system module designed as a service and comprising a Java Card CAP file in a detailed view, according to embodiments of the invention. The service contains a Java Card CAP file that contains Java code according to the Java Card specification. The Java code is contained in one or more files, the Java source files, with the Java (Card)-specific name extension *.java. The exemplary CAP file shown in FIG. 3 further contains a static resource component that can be used to add native code and resources to the Java Card CAP file. The native code can be provided in one or more files. For example, native code can be present in the *.bin or *.hex format. For example, native resources can be present in the *.txt or *.html format. The CAP file or Java code is structured in a typical Java Card manner and contains, for example, data elements such as a header, a directory, one or more applets, import information, a constant pool, classes, and the like. Native code and resources can be added to the CAP file as static resources using the static resource element.

1.-15. (canceled)

16. A method for installing, in a processor device, an operating system comprising a plurality of two or more operating system functionalities, or parts of such an operating system,
wherein the method comprises the steps of:
loading the operating system, or the parts of the operating system, into the processor device;
installing the loaded operating system, or the loaded parts of the operating system, in the processor device;
wherein
a) the loading of the operating system, or the parts of the operating system, is carried out as loading at least one or more mutually separate operating system modules, wherein the operating system module or the respective operating system module
b) contains code that is configured to install an operating system functionality corresponding to the operating system module in the processor device, and
c) allows only the operating system functionality corresponding to the respective operating system module to be installed separately, without installing further operating system functionalities.

17. The method according to claim 16, wherein the operating system module or the respective operating system module furthermore
d) is isolated from other operating system modules such that access between the operating system module or the respective operating system module and other operating system modules is prevented or is only possible at best by means of controlled interface mechanisms.

18. The method according to claim 16, wherein the installation of the operating system or the parts of the operating system is carried out:
as separate installation of the loaded separate operating system modules; or
as joint installation of the loaded separate operating system modules; or
as separate installation of the loaded separate operating system modules for some operating system modules, and as joint installation of the loaded separate operating system modules for some operating system modules.

19. The method according to claim 16, wherein the following are provided as mutually separate operating system modules:
at least one trusted loader (TL) which is configured to load further operating system modules into the processor device, and to cause the further operating system modules to be installed in the processor device; and
additionally one or more functional operating system modules (BOS, OSM1, . . . OSMn, LIBM21, LIBM2).

20. The method according to claim 19, wherein one or more of the following are provided as functional operating system modules:
a basic functionality module (BOS), the installation of which installs one or more basic functionalities of the operating system in the processor device;
a cryptographic algorithm module, the installation of which installs an implementation of a cryptographic algorithm in the processor device;
a library module (LIBM1, LIBM2), the installation of which installs a library in the processor device;
a protocol module, the installation of which installs an implementation of a protocol for communication between the processor device and units arranged outside the processor device;
an updated version of one of the preceding functional operating system modules that is loaded into the processor device and installed in the processor device as a replacement or supplement for a version of the same functional operating system module already installed in the processor device.

21. The method according to claim 20, wherein one or more of the following is or are provided as the basic functionality:
memory management of memory units of the processor device;
reading or/and writing of data, including programs, in memory units of the processor device;
editing of instructions in the processor device, including reception of instructions, execution of instructions, creation of instructions, and outputting of instructions.

22. The method according to claim 16, wherein the operating system module is designed as a Java Card CAP file according to the Java Card specification.

23. The method according to claim 16, wherein the operating system module contains Java Card code or native code, or both Java Card code and native code.

24. The method according to claim 16, wherein:
the loading of an operating system module is carried out: as loading of a service, in which the operating system module is integrated, into the processor device,
wherein a service for an operating system module for an operating system functionality is configured to be executed and thereby to install the operating system functionality in the processor device; and
an operating system module is installed by executing the loaded service in the processor device.

25. The method according to claim 24, wherein the operating system is at least partially or completely designed as a Java Card-based operating system, and
wherein the service is designed as a Java Card applet and the operating system module is designed as a Java Card CAP file,
wherein the service is executed by calling and executing the Java Card applet,
wherein the operating system functionality corresponding to the Java Card CAP file is installed in the processor device.

26. The method according to claim 25, wherein the Java Card applet used to implement the service is designed as a modified Java Card applet which is modified to the effect that the modified Java Card applet cannot be called by the process and select instructions that can be used to call a Java Card applet, but only has a controlled interface object, a shareable interface object or entry point object, and can be called thereby.

27. The method according to claim 25, wherein an application identifier, AID, is assigned to the Java Card applet, and
wherein a registry is set up in the processor device, in which the application identifier, AID, of the Java Card applet is entered when loading the applet into the processor device, and
wherein the Java Card applet is called and executed based on the application identifier, AID, entered in the registry—and optionally also using a URI string pointing to the service—,
wherein the operating system functionality corresponding to the Java Card CAP file is installed in the processor device.

28. The method according to claim 24, wherein different services for different operating system modules are carried out in different contexts which are isolated from each other, by means of the action of a microprocessor device MPU or/and memory management MPU,
wherein interaction or communication between different services is possible only via a controlled interface mechanism, a shareable interface object or/and an entry point object.

29. The method according to claim 19, wherein each operating system module is certified separately,
wherein, optionally, the trusted loader has the highest or at least no lower level of certification relative to other operating system modules.

30. The method according to claim 16, wherein a security module is provided as the processor device.
